(19) United States
(12) Patent Application Publication
(10) Pub. No.: US 2014/0357345 A1
(43) Pub. Date: Dec. 4, 2014

(54) INTERACTING WITH SPONSORED CONTENT TO EARN REWARDS

(71) Applicant: Zynga Inc., San Francisco, CA (US)

(72) Inventor: Fabio Santini, Mountain View, CA (US)

(73) Assignee: Zynga Inc., San Francisco, CA (US)

(21) Appl. No.: 14/292,371

(22) Filed: May 30, 2014

Related U.S. Application Data
(60) Provisional application No. 61/828,833, filed on May 30, 2013.

(51) Int. Cl. A63F 13/00

(52) U.S. Cl. CPC A63F 13/00
USPC 463/25

(57) ABSTRACT

Methods, systems, and computer program products for providing players with rewards are described. Data indicating that a player has selected an unavailable reward may be processed. Sponsored content based on the processed data may be obtained and presented to the player. Data indicating that the player has completed an interaction with the sponsored content may be obtained and the reward may be provided in response to processing the data that indicates that the player has completed the interaction with the sponsored content.

### RELATED APPLICATION

The present application claims the benefit of priority to U.S. Provisional Patent Application Ser. No. 61/828,833, filed May 30, 2013, which is incorporated herein by reference in its entirety.

### FIELD

The present disclosure generally relates to online social games and, more specifically, to providing player requested rewards in online games.

### BACKGROUND

Many online games present advertisements and other sponsored content to players of the online games. For example, an online game may display static advertisements within the game, dynamic advertisements within the game, and the like. Integrating an online game with advertising and other sponsored content enables a game provider to publish online games with little or no costs to players via freemium and other similar models, among other things.

### BRIEF DESCRIPTION OF THE DRAWINGS

The example embodiments are illustrated by way of example, and not limitation, in the figures of the accompanying drawings, in which like reference numerals indicate the same or similar elements unless otherwise indicated.

FIG. 1 shows a schematic diagram of a virtual gaming system, in accordance with an example embodiment.

FIG. 2 shows a social network within a social graph, in accordance with an example embodiment.

FIG. 3 is a block diagram illustrating an integrated in-game advertising platform, in accordance with an example embodiment.

FIG. 4 is a block diagram illustrating an interface system, in accordance with an example embodiment.

FIG. 5A is a flow diagram illustrating an example method for presenting an activity to a player of an online game, in accordance with an example embodiment.

FIG. 5B is a flow diagram illustrating an example method for presenting sponsored content to a player of an online game, in accordance with an example embodiment.

FIG. 5C is a flow diagram illustrating an example method for providing a player with an unavailable feed reward, in accordance with an example embodiment.

FIG. 6 shows an example embodiment of a user interface that may be displayed within a game interface showing a view of a gameboard.

FIG. 7 illustrates data flow between example components of the example system of FIG. 1, in accordance with an example embodiment.

FIG. 8 illustrates an example network environment, in accordance with an example embodiment.

FIG. 9 illustrates an example computing system architecture, which may be used to implement one or more of the methodologies described herein.

### DESCRIPTION OF EXAMPLE EMBODIMENTS

### Overview

Systems and methods for providing players with expired and/or unavailable rewards and/or incentives based on actions performed by a user are described. For example, a reward that has been presented to a user may no longer be available to the user because the reward has expired, the reward no longer exists, and the like. In some example embodiments, the systems and methods enable players to obtain rewards and/or incentives that expired and/or became unavailable by, for example, interacting with sponsored content. A reward and/or incentive that expired and/or became unavailable are known herein as a retroactively-obtained reward. The retroactively-obtained reward may be the originally-presented reward, a modified version of the originally-presented reward, or a new reward. In some example embodiments, the systems and methods enable players to renew expired rewards and/or incentives. The rewards and incentives may be associated with a game feed (e.g., a news feed associated with an online game or timelines within an associated social network) or any communication channel associated with a reward, and may be retroactively provided by an online game with feeds by, for example, watching or otherwise interacting with sponsored content, among other things.

These and other example embodiments are described, by way of example, in further detail below.

### Example Systems

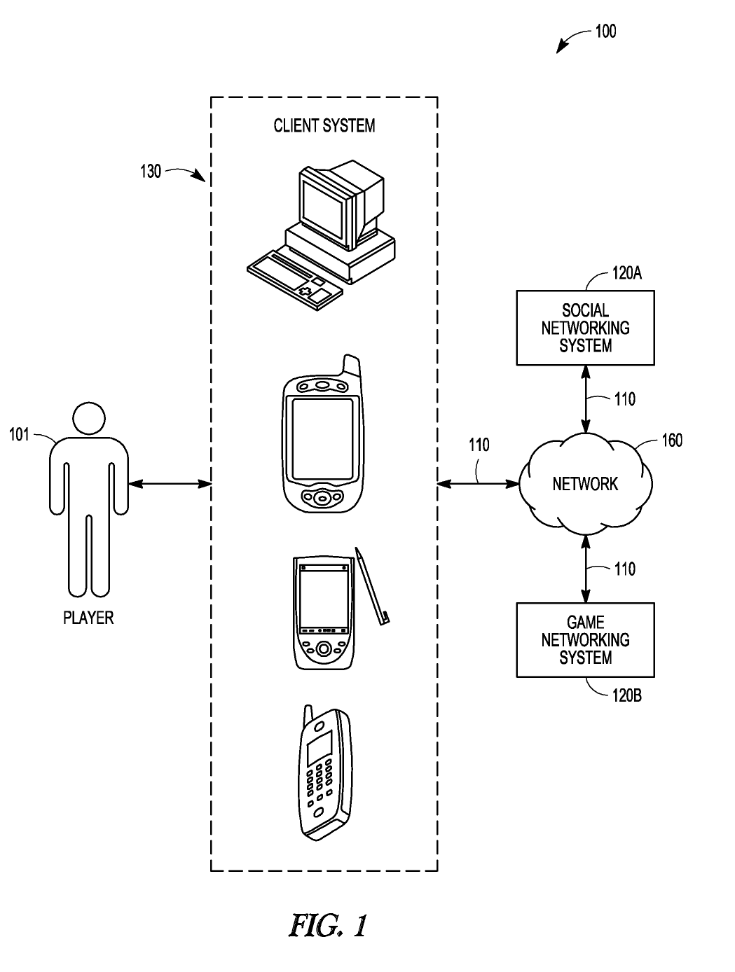

FIG. 1 illustrates an example of a system 100 for implementing various disclosed embodiments. In particular embodiments, the system 100 comprises a player 101, a social networking system 120a, a game networking system 120b, a client system 130, and a network 160. The components of the system 100 may be connected to each other in any suitable configuration, using any suitable type of connection. The components may be connected directly or over a network 160, which may be any suitable network. For example, one or more portions of the network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

The social networking system 120a may be a network-addressable computing system that can host one or more social graphs. The social networking system 120a may generate, store, receive, and transmit social networking data. The social networking system 120a may be accessed by the other components of the system 100 either directly or via the network 160. The game networking system 120b is a network-addressable computing system that may host one or more online games. The game networking system 120b may generate, store, receive, and transmit game-related data, such as, for example, game account data, game input, game state data, and game displays. The game networking system 120b may be accessed by the other components of the system 100 either directly or via network 160. The player 101 may use the client system 130 to access, send data to, and receive data from the social networking system 120a and the game networking system 120b. The client system 130 may access the social networking system 120a or the game networking system 120b directly, via the network 160, or via a third-party system. For example, the client system 130 may access the game networking system 120b via the social networking system 120a. The client system 130 may be any suitable computing device, such as a personal computer, laptop, cellular phone, smart phone, computing tablet, and the like.

The components of the system 100 may be connected to each other using any suitable connections 110. For example, the suitable connections 110 may include wireline (e.g., Digital Subscriber Line (DSL) or Data Over Cable Service Interface Specification (DOCSIS)), wireless (e.g., Wi-Fi or Worldwide Interoperability for Microwave Access (WiMAX)) or optical (e.g., Synchronous Optical Network (SONET) or Synchronous Digital Hierarchy (SDH)) connections. One or more connections 110 may include an ad hoc network, an intranet, an extranet, a VPN, a LAN, a WLAN, a WAN, a WWAN, a MAN, a portion of the Internet, a portion of the PSTN, a cellular telephone network, another type of connection, or a combination of two or more such connections. The connections 110 need not necessarily be the same throughout the system 100. One or more first connections 110 may differ in one or more respects from one or more second connections 110.

In an online computer game, a game engine manages a game state of the game. The game state may comprise all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs) and in-game objects. The game engine also manages game state, including player character state for currently active (online) and inactive (offline) players.

An online game may be hosted by the game networking system 120b, which can be accessed using any suitable connection 110 with a suitable client system 130. A player 101 may have a game account on the game networking system 120b, wherein the game account can contain a variety of information associated with the player 101 (e.g., the player's personal information, financial information, purchase history, player character state, game state, and the like). In some example embodiments, the player 101 may play multiple games on the game networking system 120b, which may maintain a single game account for the player 101 with respect to all the games, or multiple individual game accounts for each game with respect to the player 101. In some example embodiments, the game networking system 120b may assign a unique identifier to each player 101 of an online game hosted on the game networking system 120b. The game networking system 120b may determine that a player 101 is accessing the online game by reading the user's cookies, which may be appended to hypertext transfer protocol (HTTP) requests transmitted by the client system 130, and/or by the player 101 logging onto the online game.

In some example embodiments, the player 101 may access an online game and control the game's progress via the client system 130 (e.g., by inputting commands to the game at the client device). The client system 130 may display the game interface, receive inputs from the player 101, transmit user inputs or other events to the game engine, and receive instructions from the game engine. The game engine can be executed on any suitable system (e.g., the client system 130, the social networking system 120a, and/or the game networking system 120b). For example, the client system 130 may download client components of an online game, which are executed locally, while a remote game server, such as the game networking system 120b, provides backend support for the client components and may be responsible for maintaining application data of the game, processing the inputs from the player 101, updating and/or synchronizing the game state based on the game logic and each input from the player 101, and transmitting instructions to the client system 130. As another example, each time the player 101 provides an input to the game through the client system 130 (e.g., by typing on the keyboard or clicking the mouse of client system 130), the client components of the game may transmit the player's input to the game networking system 120b.

In an online multiplayer game, players may control player characters (PCs), while a game engine controls non-player characters (NPCs) and game features, and the game engine also manages player character state and game state and tracks the state for currently active (i.e., online) players and currently inactive (i.e., offline) players. A player character can have a set of attributes and a set of friends associated with the player character. As used herein, a term “player character state” can refer to any in-game characteristic of a player character, such as location, assets, levels, condition, health, status, inventory, skill set, name, orientation, affiliation, specialty, and the like. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), and so forth. The game engine may use the player character state to determine the outcome of game events, while also sometimes considering set or random variables. Generally, a player character's probability of having a more favorable outcome is greater when the player character has a better state. For example, a healthier player character is less likely to die in a particular encounter relative to a weaker player character or non-player character. In some embodiments, the game engine can assign a unique client identifier to each player 101.

In some example embodiments, the player 101 may access particular game instances of an online game. A game instance is a copy of a specific game play area that is created during runtime. In some example embodiments, a game instance is a discrete game play area where one or more players 101 may interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In some example embodiments, a game instance is populated by one or more player characters controlled by one or more players 101 and one or more in-game objects controlled by the game engine. When accessing an online game, the game engine may allow the player 101 to select a particular game instance to play from a plurality of game instances. Alternatively, the game engine may automatically select the game instance that the player 101 will access. In some example embodiments, an online game comprises only one game instance that all players 101 of the online game can access.

In some example embodiments, a specific game instance may be associated with one or more specific players 101. A game instance is associated with a specific player 101 when one or more game parameters of the game instance are associated with the specific player 101. For example, a game instance associated with a first player 101 may be named “First Player's Play Area.” This game instance may be populated with the first player's PC and one or more in-game objects associated with the first player 101. In some example embodiments, a game instance associated with a specific player 101 may only be accessible by that specific player 101. For example, a first player 101 may access a first game instance when playing an online game, and this first game instance may be inaccessible to all other players 101. In other embodiments, a game instance associated with a specific player 101 may be accessible by one or more other players, either synchronously or asynchronously with the specific player's game play. For example, a first player 101 may be associated with a first game instance, but the first game instance may be accessed by all first-degree friends in the first player's social network. In some example embodiments, the game engine may create a specific game instance for a specific player 101 when that player 101 accesses the game. For example, the game engine may create a first game instance when a first player 101 initially accesses an online game, and that same game instance may be loaded each time the first player 101 accesses the game. For example, the game engine may create a new game instance each time a first player 101 accesses an online game, wherein each game instance may be created randomly or selected from a set of predetermined game instances. In some example embodiments, the set of in-game actions available to a specific player 101 may be different in a game instance that is associated with that player 101 compared to a game instance that is not associated with that player 101. The set of in-game actions available to a specific player in a game instance associated with that player 101 may be a subset, superset, or independent of the set of in-game actions available to that player 101 in a game instance that is not associated with him. For example, a first player 101 may be associated with Blackacre Farm in an online farming game. The first player 101 may be able to plant crops on Blackacre Farm. If the first player 101 accesses a game instance associated with another player 101, such as Whiteacre Farm, the game engine may not allow the first player 101 to plant crops in that game instance. However, other in-game actions may be available to the first player 101, such as watering or fertilizing crops on Whiteacre Farm.

In some example embodiments, a game engine can interface with a social graph. Social graphs are models of connections between entities (e.g., individuals, users, contacts, friends, players, player characters, non-player characters, businesses, groups, associations, concepts, and the like). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some example embodiments, a unique client identifier can be assigned to each user in the social graph. This disclosure assumes that at least one entity of a social graph is a player or player character in an online multiplayer game, though this disclosure includes any suitable social graph users.

The minimum number of edges required to connect a player (or player character) to another user is considered the degree of separation between them. For example, where the player and the user are directly connected (one edge), they are deemed to be separated by one degree of separation. The user would be a so-called “first-degree friend” of the player. Where the player and the user are connected through one other user (two edges), they are deemed to be separated by two degrees of separation. This user would be a so-called “second-degree friend” of the player. Where the player and the user are connected through N edges (or N−1 other users), they are deemed to be separated by N degrees of separation. This user would be a so-called “Nth-degree friend.” As used herein, the term “friend” means only first-degree friends, unless context suggests otherwise.

Within the social graph, each player (or player character) has a social network. A player's social network includes all users in the social graph within Nₘₐₓ degrees of the player, where Nₘₐₓ is the maximum degree of separation allowed by the system managing the social graph (e.g., the social networking system 120a or the game networking system 120b). In some example embodiments, Nₘₐₓ equals 1, such that the player's social network includes only first-degree friends. In some example embodiments, Nₘₐₓ is unlimited and the player's social network is coextensive with the social graph.

In some example embodiments, the social graph is managed by the game networking system 120b, which is managed by the game operator. In other embodiments, the social graph is part of a social networking system 120a managed by a third-party (e.g., Facebook®, Friendster, Myspace). In other embodiments, the player 101 has a social network on both the game networking system 120b and the social networking system 120a, wherein the player 101 can have a social network on the game networking system 120b that is a subset, superset, or independent of the player's social network on the social networking system 120a. In such combined systems, the game networking system 120b may maintain social graph information with edge type attributes that indicate whether a given friend is an “in-game friend,” an “out-of-game friend,” or both. The various embodiments disclosed herein are operable when the social graph is managed by social networking system 120a, game networking system 120b, or both.

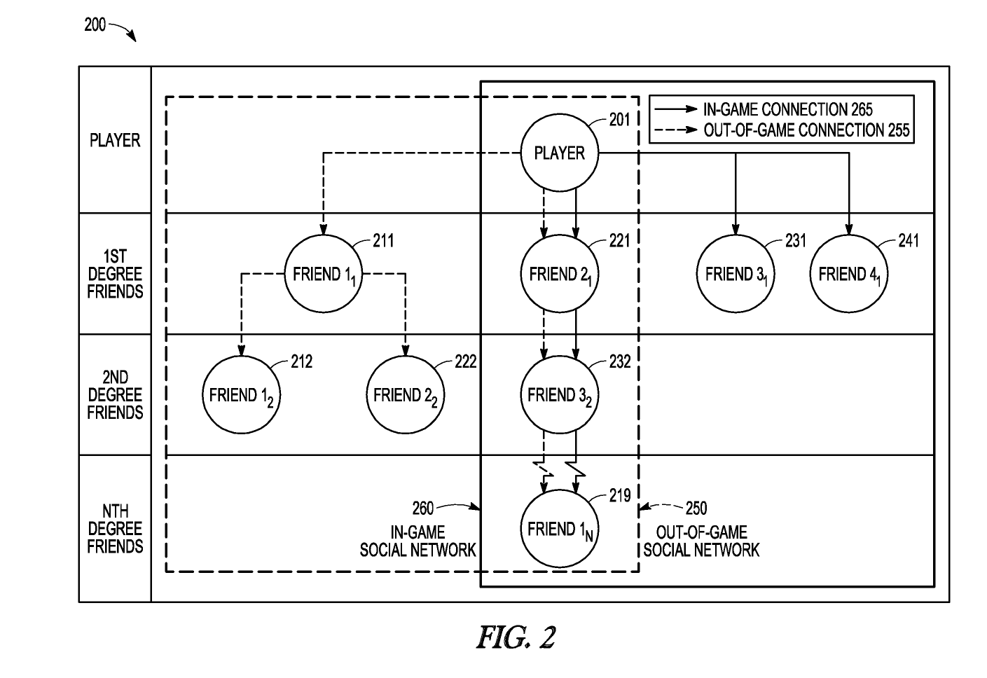

FIG. 2 shows an example of a social network 200 within a social graph, in accordance with an example embodiment. As shown, Player 201 can be associated, connected, or linked to various other users, or “friends,” within the social network 200. These associations, connections, or links can track relationships between users within the social network 200 and are commonly referred to as online “friends” or “friendships” between users. Each friend or friendship in a particular user's social network within a social graph is commonly referred to as a “node.” For purposes of illustration and not by way of limitation, the details of the social network 200 will be described in relation to Player 201. As used herein, the terms “player” and “user” can be used interchangeably and can refer to any user or character in an online multiuser game system or social networking system. As used herein, the term “friend” can mean any node within a player's social network.

As shown in FIG. 2, Player 201 has direct connections with several friends. When Player 201 has a direct connection with another individual, the connection is referred to as a first-degree friend. In the social network 200, Player 201 has two first-degree friends. That is, Player 201 is directly connected to Friend 1₁ 211 and Friend 2₁ 221. In a social graph, it is possible for individuals to be connected to other individuals through their first-degree friends (i.e., friends of friends). As described above, each edge required to connect a player to another user is considered the degree of separation. For example, FIG. 2 shows that Player 201 has three second-degree friends to which he is connected via his connection to his first-degree friends. Second-degree Friend 1₂ 212 and Friend 2₂ 222 are connected to Player 201 via his first-degree Friend 1₁ 211 and second-degree Friend 3₂ 232 is connected to Player 201 via his first-degree Friend 2₁ 221. The limit on the depth of friend connections, or the number of degrees of separation for associations, that Player 201 is allowed is typically dictated by the restrictions and policies implemented by social networking system 120a.

In some example embodiments, Player 201 can have Nth-degree friends connected to him through a chain of intermediary degree friends as indicated in FIG. 2. For example, Nth-degree Friend 1_{N} 219 is connected to Player 201 via second-degree Friend 3₂ 232 and one or more other higher-degree friends. Various embodiments may take advantage of and utilize the distinction between the various degrees of friendship relative to Player 201.

In some example embodiments, a player (or player character) may have a social graph within an online multiplayer game that is maintained by the game engine and another social graph maintained by a separate social networking system. FIG. 2 depicts an example of an in-game social network 260 and the out-of-game social network 250. As discussed herein, Player 201 has out-of-game connections 255 to a plurality of friends, forming out-of-game social network 250. Here, Friend 1₁ 211 and Friend 2₁ 221 are first-degree friends with Player 201 in his out-of-game social network 250. Player 201 also has in-game connections 265 to a plurality of players, forming in-game social network 260. That is, Friend 2₁ 221, Friend 3₁ 231, and Friend 4₁ 241 are first-degree friends with Player 201 in his in-game social network 260. In some embodiments, it is possible for a friend to be in both the out-of-game social network 250 and the in-game social network 260. For example, Friend 2₁ 221 has both an out-of-game connection 255 and an in-game connection 265 with Player 201, such that Friend 2₁ 221 is in both Player 201's in-game social network 260 and Player 201's out-of-game social network 250.

As with other social networks, Player 201 may have second-degree and higher-degree friends in both his in-game and out of game social networks. In some embodiments, it is possible for Player 201 to have a friend connected to him both in his in-game and out-of-game social networks, wherein the friend is at different degrees of separation in each network. For example, if Friend 2₂ 222 had a direct in-game connection with Player 201, Friend 2₂ 222 would be a second-degree friend in Player 201's out-of-game social network, but a first-degree friend in Player 201's in-game social network. In particular embodiments, a game engine can access the in-game social network 260, the out-of-game social network 250, or both.

In some example embodiments, the connections in a player's in-game social network can be formed both explicitly (e.g., users should “friend” each other) and implicitly (e.g., system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (i.e., in disintermediated interactions or the like), but that could be the case.

Example of Integrated in-Game Advertisement Platform

In some example embodiments, the systems and methods described herein provide an integrated interface to different advertisement providers, in order to provide a single user experience/interaction between users/players of online games and the presented advertisements, among other benefits. The systems and methods may present advertisements and other sponsored messages in various formats, such as Joint Photographic Experts Group (JPEG), video, HyperText Markup Language 5 (HTML5), and the like. For example, different media inputs are converted to a single user interface (UI) to provide a uniform, transparent experience to the user. That is, the entire user experience, from load to completion (and any interaction with the media, such as rewards), may take place within the single UI, among other things.

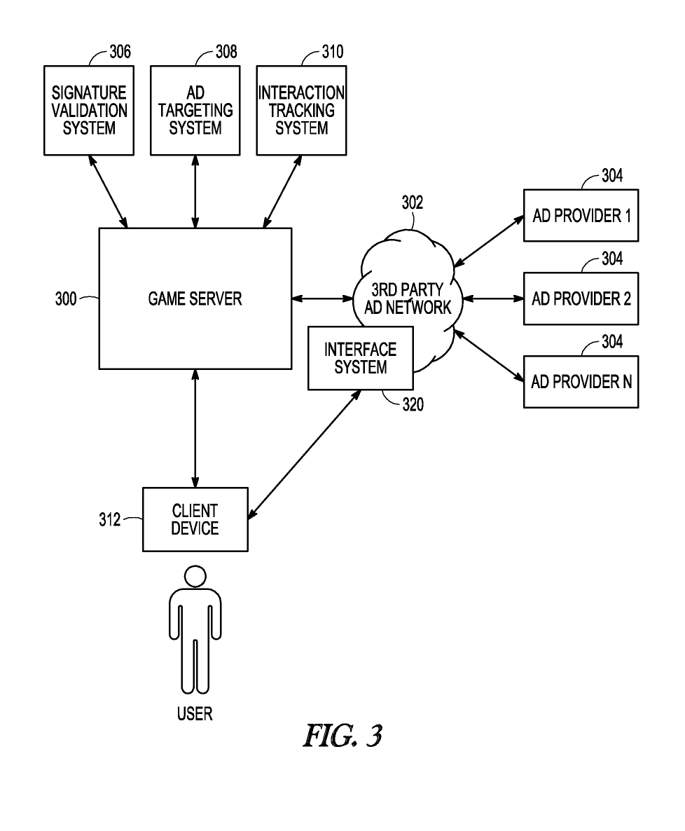

FIG. 3 is a block diagram illustrating an integrated in-game advertising platform, in accordance with an example embodiment. The platform may include a game server 300 that communicates with a third party advertisement network 302. The third party advertisement network 302 is configured to provide actions to be performed by a user, such as viewing advertisements or other sponsored content from, for example, various sponsored content providers 304 (e.g., Ad Provider 1, Ad Provider 2, Ad Provider N), such as game sponsors and other sponsoring entities. The game server 300 and/or the advertisement network 302 may provide advertisements and other sponsored content to a user device 312, such as within or overlaying a game fiction of an online game provided by the game server 300.

The game server 300 may also communicate with various systems that perform methods associated with presenting actions to be performed by a user, such as viewing advertisements and other sponsored content via user devices 312. The systems may include a signature validation system 306 configured to validate devices within the platform, an ad targeting system 308 configured to identify, target, and/or match advertisements to users, and/or an interaction tracking system 310 configured to track interactions between users and interactions with presented advertisements.

The following is an example of different components that may interact between the game server 300 and an interface system 320 associated with the third party advertisement network 302 in order to resolve friction points within online games based on the presentation of interactive advertisements:

Once an online game is launched, the game server 300 initializes Flash based on an initUser transaction. The game server 300 fetches targeting information from a targeting service, such as the ad targeting system 308. At the same time or in parallel, the game server 300 initializes the online game code (e.g., game HTML or JavaScript), by (1) fetching 3PAN playloads from a ZRuntime script, and (2) outputting an appropriate 3PAN payload into a page stream to create a 3PAN JavaScript module which can retrieve interactive content from the third party advertisement network 302. At a friction point, the game server 300, via Flash, identifies available content to view or other actions to perform. Examples of a friction point, or pinch point, include a status of a game task, a low level of a gaming resource, a low level of available gaming time, an occurrence of a player running out of energy, a low or empty account of virtual currency, failing a task or quest within the online game, sharing or giving a gift, enlisting the help of another player or a friend, and the like.

If available, the game server 300 presents an option to view the content or perform the action, and when the user selects the option, the 3PAN payload calls a load function with a pointer to the div/frame that is rendering the retrieved content. Upon completion of a presentation of the content, the 3PAN payload transmits a “completed message” to the game server 300, and closes the content window. The game server 300 then resolves the friction point by granting energy or performing other transactions within the online game.

In some example embodiments, displayed advertisements may be in a rich-media format, and include a video piece along with a survey or quiz questions. In one example embodiment, the advertisements may include arbitrary web content (pure video, display only, rich media, and the like). In some example embodiments, the game server 300 may utilize an IFrame window triggered from a Flash or HTML5 game client as the content placement mechanism.

In some example embodiments, the interface system 320 may provide a software development kit (SDK) that reduces in-game integration costs, among other things. The SDK may also provide uniform tracking and allow the interface system 320 to manage onboard new advertisement networks and/or content providers without game studio development involvement. The system may also integrate with a targeting engine, such as ad targeting system 308, to provide the ability to target the advertisements themselves, as well as target in-game placements to different user segments based on geography, demographics, behavior, and the like.

As described herein, in some example embodiments, the third party advertisement network 302 may provide a single and/or integrated interface, such as an interface system 320, that includes components that perform various methods for presenting actions to be performed by a user, advertisements, and other sponsored content to players of an online game, such as to resolve friction points within a game fiction or dialog, among other things.

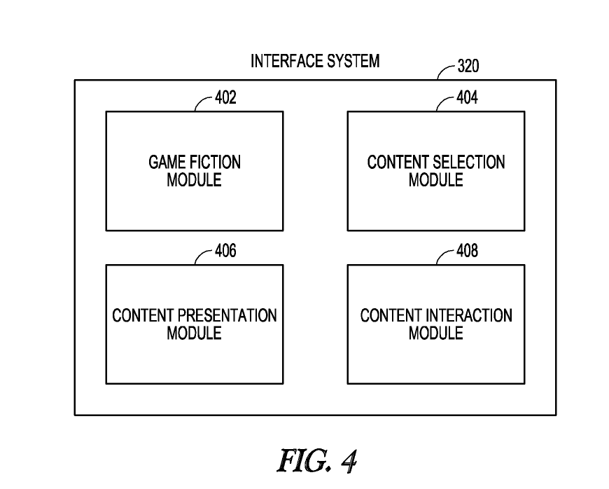

FIG. 4 is a block diagram illustrating the interface system 320, in accordance with an example embodiment. The interface system 320 may include various hardware and/or software modules, such as a game fiction module 402, a content selection module 404, a content presentation module 406, and a content interaction module 408.

In some example embodiments, the game fiction module 402 is configured and/or programmed to receive an indication of an occurrence of a trigger event within a game fiction of an online game. For example, the game fiction module 402 may receive from the game server 300 an indication that a player of an online game has arrived at a friction point or pinch point within a game fiction, such as a level of a gaming resource and/or gaming asset; and a status of a game task.

In some example embodiments, the game content selection module 404 is configured and/or programmed to select interactive sponsored content from a group of content providers to be presented to the player of the online game. For example, the content selection module 404 may select interactive content (e.g., an interactive advertisement such as a video, quiz, and the like) from the Ad Providers 304, based on information received from the game server 300, such as information from the ad targeting system 308 that provides information associated with characteristics of a player playing the online game, a state of the online game, and the like. In some example embodiments, the game content selection module 404 is configured and/or programmed to select predefined actions to be presented to the player of the online game.

In some example embodiments, the content presentation module 406 is configured and/or programmed to directly (or, indirectly via the game server 300) present the interactive content to a user device associated with a player of an online game. For example, the content presentation module 406 directly presents the interactive content to the client device 312 by overlaying the content over an online game provided by the game server 300 that is currently running on the client device 312.

In some example embodiments, the content interaction module 408 is configured and/or programmed to determine that the player of the online game has interacted with the presented interactive content or perform another identified action. For example, the content interaction module 408 may determine that a video has played, a player has answered one or more questions from a displayed interactive quiz, the player has viewed content, and the like. In one example embodiment, the content interaction module 408 may determine that a player has performed a particular action in a game, invited a friend to participate in an event, shared an item with friends via social media, made a particular purchase, shared personal information (such as a phone number), provided a product or service review or evaluation, logged into a game a defined number of times, participated in a game for a defined amount of time, and/or provided a suggestion.

Once it has been determined that the player has interacted with the presented interactive content or performed the presented action, the game fiction module 402 may transmit to the game server 300 an indication that the player has interacted with the presented interactive content or performed the presented action, and the game server 300 may resolve the trigger event (e.g., friction point) based on the indication, among other things.

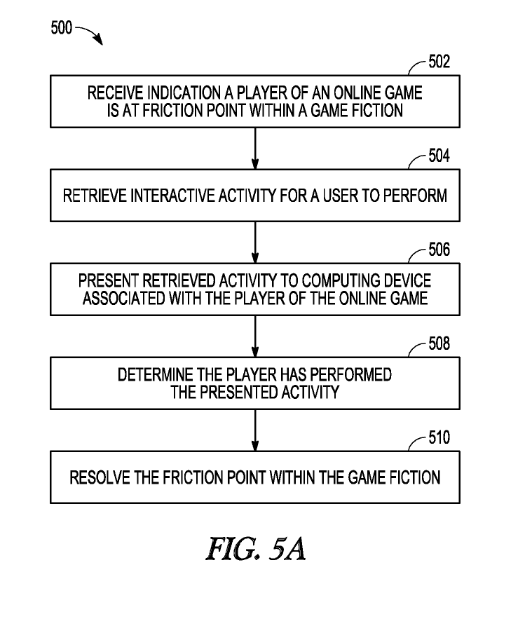

FIG. 5A is a flow diagram illustrating an example method 500 for presenting an activity to a player of an online game, in accordance with an example embodiment. In operation 502, the interface system 320 receives an indication that a player of an online game is at a friction point, or pinch point, within a game fiction. For example, the game fiction module 402 receives an indication from the game server 300 that a player has reached a friction point or pinch point within a game fiction. Example friction points may include running low or out of energy, running low or out of virtual currency, running low or out of time to complete a task or project within the game, failing to complete a task or project within the game, losing a competition within the online game, and the like. In one example embodiment, friction points within the game fiction may comprise progression of a player to a particular point within a game fiction. In one example embodiment, operation 502 is an optional operation; the method 500 may begin with operation 504 and an activity may be retrieved without receiving an indication that a player of an online game is at a friction point.

In operation 504, the interface system 320 retrieves an activity from, for example, a third party network of, for example, advertisement providers. For example, the content selection module 404 selects and retrieves an interactive advertisement (e.g., a video or interactive quiz) from one of the multiple content providers associated with the third party advertisement network 302.

In operation 506, the interface system 320 presents the action to be performed directly to a computing device associated with a player of the online game. For example, the content presentation module 406 overlays a presentation of a retrieved advertisement on top of a currently running game within the client device 312.

In operation 508, the interface system 320 determines that the player of the online game has completed the presented activity. For example, the content interaction module 408 determines that an interactive advertisement has completed the presentation of a video at the client device 312.

In operation 510, in response to the determination that the player of the online game has interacted with the interactive advertisement, the interface system 320 transmits an indication to the game server 300 that the player has interacted with sponsored content, and the game server 300 resolves the friction point within the game fiction of the online game.

FIG. 5B is a flow diagram illustrating an example method 550 for presenting sponsored content to a player of an online game, in accordance with an example embodiment. In operation 552, the interface system 320 receives an indication that a player of an online game is at a friction point within a game fiction. For example, the game fiction module 402 receives an indication from the game server 300 that a player has reached a friction point or pinch point within a game fiction. Example friction points may include running low or out of energy, running low or out of virtual currency, running low or out of time to complete a task or project within the game, failing to complete a task or project within the game, losing a competition within the online game, and the like.

In operation 554, the interface system 320 retrieves sponsored interactive content from a third party network of advertisement providers. For example, the content selection module 404 selects and retrieves an interactive advertisement (e.g., a video or interactive quiz) from one of the multiple content providers associated with the third party advertisement network 302.

In operation 556, the interface system 320 presents the retrieved interactive content directly to a computing device associated with a player of the online game. For example, the content presentation module 406 overlays a presentation of a retrieved advertisement on top of a currently running game within the client device 312.

In operation 558, the interface system 320 determines that the player of the online game has interacted with the presented interactive sponsored content. For example, the content interaction module 408 determines that an interactive advertisement has completed the presentation of a video at the client device 312.

In operation 560, in response to the determination that the player of the online game has interacted with the interactive advertisement, the interface system 320 transmits an indication to the game server 300 that the player has interacted with sponsored content, and the game server 300 resolves the friction point within the game fiction of the online game.

For example, the game server 300 may resolve a friction point by awarding a player energy or virtual currency, by assisting a player with a quest, and the like.

In some example embodiments, the game server 300 may perform method 500, 550 at various other times within a game fiction, such as other points within a game fiction that may require a player to perform a task or other action with an online game, at times when a player's status or associated metrics indicate a possible need for a reward (e.g., the player is running low on energy), or in response to player input triggering a sponsored content presentation process.

### Providing Expired or Unavailable Feed Rewards to Players of Online Games

As described herein, in some example embodiments, the systems and methods may enable players to retroactively obtain and/or redeem rewards and incentives provided by an online game with feeds (e.g., timelines within an associated social network) by watching or otherwise interacting with sponsored content, among other things. FIG. 5C is a flow diagram illustrating an example method 570 for providing a player with an unavailable feed reward, consistent with some embodiments.

In operation 575, the interface system 320 determines that a player has selected an unavailable feed reward. For example, the interface system 320 may determine that a player is viewing an item within a feed (e.g., a feed landing page or timeline within a social network), such as an item providing a reward that is currently unavailable. For example, an unavailable reward may be an expired reward, a reward redeemed by another player or players, and the like.

In operation 580, the interface system 320 presents, for example, sponsored content to the player. For example the interface system 320 may present a video or series of videos, an interactive quiz, or other sponsored content. The sponsored content may be based on the requested reward (e.g., the reward displayed in the feed landing page).

In operation 585, the interface system 320 provides the reward in response to a completed interaction between the player and the sponsored content. For example, the interface system 320 may determine a player has completed an action, such as viewing a video or completing an interactive quiz, and provides the reward to the player. Example rewards may include virtual cash or currency, virtual items or objects, energy, powerups, and other reward, awards, and/or incentives described herein.

Thus, in some example embodiments, the systems and methods described herein enable players to redeem and/or obtain unavailable feed rewards from feed landing pages, which may provide an online game or game published with deeper engagements between players and advertisements, advertising experiences that do not cause game interruptions (e.g., experiences outside of the online game play), and the like.

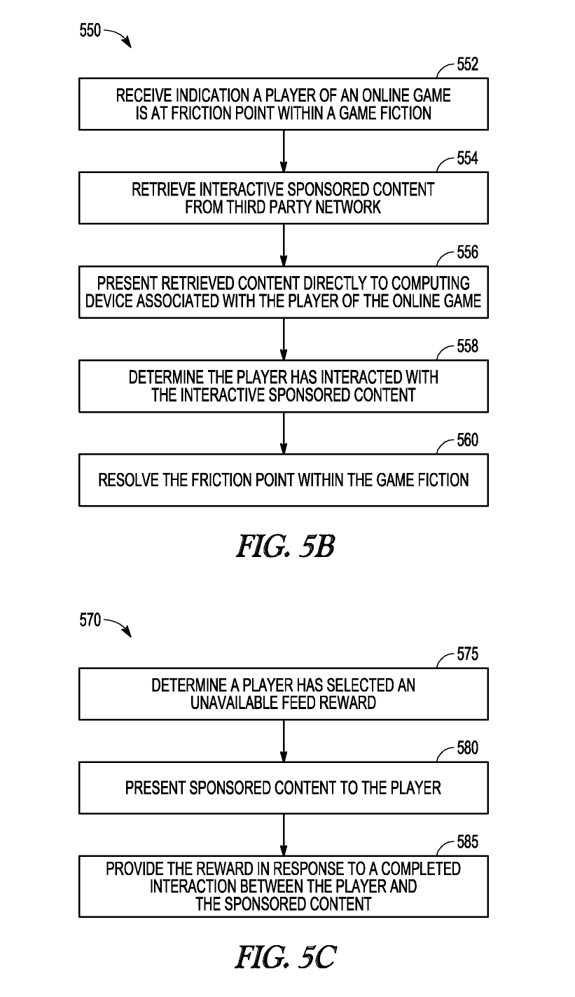

FIG. 6 shows an example embodiment of a user interface (UI) 600 that may be displayed within a game interface 605 showing a view of a gameboard (in this example embodiment a virtual in-game space consisting of the player's game instance, which is a virtual city developed and managed by the player). The UI 600 includes an ad prompt 620 that provides a user-selectable user interface element (in this example embodiment, a “watch ad” soft button) that can be selected by the player to launch an associated video ad. UI 600 further includes a benefit type icon 615 that indicates the type of benefit offered as a reward, in this example embodiment comprising energy boosts consumable by the player within game play. The UI 600 further includes an amount icon 610 that indicates an amount of the corresponding game resource (in this example indicating the number of energy boosts) that are offered as the reward.

Returning now to FIG. 5B, it can be seen that the method 550 includes determining, at operation 558, that the player has interacted with the sponsored content. In the example embodiment of FIG. 6, this may comprise determining that the player has selected the ad prompt provided by soft button 620, and has played the corresponding video ad to completion.

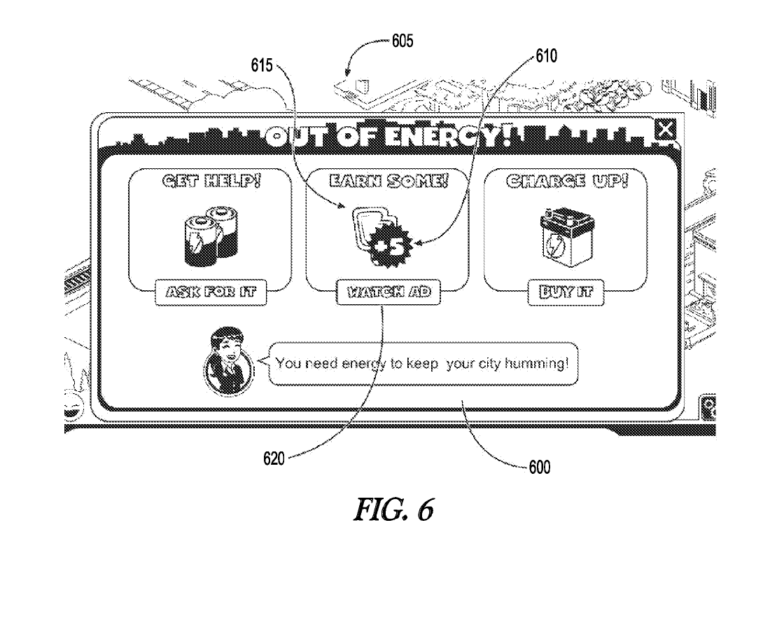

FIG. 7 illustrates an example data flow between the components of system 1100, in accordance with some example embodiments. In particular embodiments, system 1100 can include client system 1130, social networking system 1120a, and game networking system 1120b. The components of system 1100 can be connected to each other in any suitable configuration, using any suitable type of connection. The components may be connected directly or over any suitable network. Client system 1130, social networking system 1120a, and game networking system 1120b can each have one or more corresponding data stores such as local data store 1125, social data store 1145, and game data store 1165, respectively. Social networking system 1120a and game networking system 1120b can also have one or more servers that can communicate with client system 1130 over an appropriate network. Social networking system 1120a and game networking system 1120b can have, for example, one or more internet servers for communicating with client system 1130 via the Internet. Similarly, social networking system 1120a and game networking system 1120b can have one or more mobile servers for communicating with client system 1130 via a mobile network (e.g., Global System for Mobile communications (GSM), PCS, Wi-Fi, wireless personal area network (WPAN), and the like). In some embodiments, one server may be able to communicate with client system 1130 over both the Internet and a mobile network. In other embodiments, separate servers can be used.

Client system 1130 can receive and transmit data 1123 to and from game networking system 1120b. This data can include, for example, webpages, messages, game inputs, game displays, HTTP packets, data requests, transaction information, updates, and other suitable data. At some other time, or at the same time, game networking system 1120b can communicate data 1143, 1147 (e.g., game state information, game system account information, page information, messages, data requests, updates, and the like) with other networking systems, such as social networking system 1120a (e.g., Facebook®, Myspace, and the like). Client system 1130 can also receive and transmit data 1127 to and from social networking system 1120a. This data can include, for example, webpages, messages, social graph information, social network displays, HTTP packets, data requests, transaction information, updates, and other suitable data.

Communication between client system 1130, social networking system 1120a, and game networking system 1120b can occur over any appropriate electronic communication medium or network using any suitable communications protocols. For example, client system 1130, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as HTTP, Hypertext Transfer Protocol Secure (HTTP-S), FTP, SNMP, TELNET, and a number of other protocols. In addition, a server in one interaction context may be a client in another interaction context. In particular embodiments, the information transmitted between hosts may be formatted as HTML documents. Other structured document languages or formats can be used, such as Extensible Markup Language (XML), and the like. Executable code objects, such as JavaScript and ActionScript, can also be embedded in the structured documents.

In some client-server protocols, such as HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called Binary Large Object (BLOB). When a player accesses an online game on game networking system 1120b, the BLOB containing the game state for the instance corresponding to the player can be transmitted to client system 1130 for a client-side executed object to process. In particular embodiments, the client-side executable may be a FLASH-based game, which can de-serialize the game state data in the BLOB. As a player plays the game, the game logic implemented at client system 1130 maintains and modifies the various game state parameters locally. The client-side game logic may also batch game events, such as mouse clicks, and transmit these events to game networking system 1120b. Game networking system 1120b may itself operate by retrieving a copy of the BLOB from a database or an intermediate memory cache (memcache) layer. Game networking system 1120b can also de-serialize the BLOB to resolve the game state parameters and execute its own game logic based on the events in the batch file of events transmitted by the client to synchronize the game state on the server side. Game networking system 1120b may then re-serialize the game state, now modified, into a BLOB and pass this to a memory cache layer for lazy updates to a persistent database.

With a client-server environment in which the online games may run, one server system, such as game networking system 1120b, may support multiple client systems 1130. At any given time, there may be multiple players at multiple client systems 1130, all playing the same online game. In practice, the number of players playing the same game at the same time may be very large. As the game progresses with each player, multiple players may provide different inputs to the online game at their respective client systems 1130, and multiple client systems 1130 may transmit multiple player inputs and/or game events to game networking system 1120b for further processing. In addition, multiple client systems 1130 may transmit other types of application data to game networking system 1120b.

In particular embodiments, a computer-implemented game may be a text-based or turn-based game implemented as a series of web pages that are generated after a player selects one or more actions to perform. The web pages may be displayed in a browser client executed on client system 1130. As an example and not by way of limitation, a client application downloaded to client system 1130 may operate to serve a set of webpages to a player. As another example and not by way of limitation, a computer-implemented game may be an animated or rendered game executable as a stand-alone application or within the context of a webpage or other structured document. In particular embodiments, the computer-implemented game may be implemented using Adobe Flash-based technologies. As an example and not by way of limitation, a game may be fully or partially implemented as a SWF (Small Web Format) object that is embedded in a web page and executable by a Flash media player plug-in. In particular embodiments, one or more described webpages may be associated with or accessed by social networking system 1120a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 1130, either caused by an action of a game player or by the game logic itself, client system 1130 may need to inform game networking system 1120b of the update. For example, if the game is a farming game with a harvest mechanic (such as Zynga® FarmVille), an event can correspond to a player clicking on a parcel of land to harvest a crop. In such an instance, the application event data may identify an event or action (e.g., harvest) and an object in the game to which the event or action applies. For illustration purposes and not by way of limitation, system 1100 is discussed in reference to updating a multi-player online game hosted on a network-addressable system (such as, for example, social networking system 1120a or game networking system 1120b), where an instance of the online game is executed remotely on a client system 1130, which then transmits application event data to the hosting system such that the remote game server synchronizes game state associated with the instance executed by the client system 1130.

In particular embodiments, one or more objects of a game may be represented as an Adobe® Flash (or other authoring environment, such as HTML5) object. Flash may manipulate vector and raster graphics, and supports bidirectional streaming of audio and video. “Flash” may mean the authoring environment, the player, or the application files. In particular embodiments, client system 1130 may include a Flash client. The Flash client may be configured to receive and run Flash application or game object code from any suitable networking system (such as, for example, social networking system 1120a or game networking system 1120b). In particular embodiments, the Flash client may be run in a browser client executed on client system 1130. A player can interact with Flash objects using client system 1130 and the Flash client. The Flash objects can represent a variety of in-game objects. Thus, the player may perform various in-game actions on various in-game objects by making various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 1130, the Flash client may send the events that caused the game state changes to the in-game object to game networking system 1120b. However, to expedite the processing and hence the speed of the overall gaming experience, the Flash client may collect a batch of some number of events or updates into a batch file. The number of events or updates may be determined by the Flash client dynamically or determined by game networking system 1120b based on server loads or other factors. For example, client system 1130 may send a batch file to game networking system 1120b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at client system 1130. In particular embodiments, the batch file may be a text file and the name-value pairs may be in string format.

In particular embodiments, when a player plays an online game on client system 1130, game networking system 1120b may serialize all the game-related data, including, for example and without limitation, game states, game events, and user inputs, for this particular user and this particular game into a BLOB and store the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game the player is in. When a player resumes playing the game next time, game networking system 1120b may retrieve the corresponding BLOB from the database to determine the most-recent values of the game-related data. In particular embodiments, while a player is playing the online game, game networking system 1120b may also load the corresponding BLOB into a memory cache so that the game system may have faster access to the BLOB and the game-related data contained therein.

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

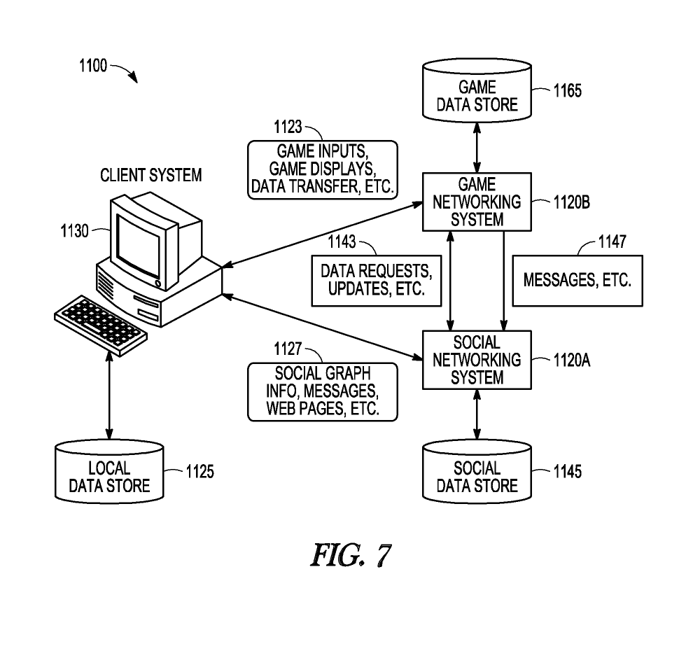

Particular embodiments may operate in a WAN environment, such as the Internet, including multiple network addressable systems. FIG. 8 illustrates an example network environment 1200, in which various example embodiments may operate. Network cloud 1260 generally represents one or more interconnected networks, over which the systems and hosts described herein can communicate. Network cloud 1260 may include packet-based WANs (such as the Internet), private networks, wireless networks, satellite networks, cellular networks, paging networks, and the like. As FIG. 8 illustrates, particular embodiments may operate in a network environment comprising one or more networking systems, such as social networking system 1220a, game networking system 1220b, and one or more client systems 1230. The components of social networking system 1220a and game networking system 1220b operate analogously; as such, hereinafter they may be referred to simply as networking system 1220. Client systems 1230 are operably connected to the network environment via a network service provider, a wireless carrier, or any other suitable means.

Networking system 1220 is a network addressable system that, in various example embodiments, comprises one or more physical servers 1222 and data stores 1224. The one or more physical servers 1222 are operably connected to network cloud 1260 via, by way of example, a set of routers and/or networking switches 1226. In an example embodiment, the functionality hosted by the one or more physical servers 1222 may include web or HTTP servers, FTP servers, as well as, without limitation, webpages and applications implemented using Common Gateway Interface (CGI) script, PHP Hyper-text Preprocessor (PHP), Active Server Pages (ASP), HTML, XML, Java, JavaScript, Asynchronous JavaScript and XML (AJAX), Flash, ActionScript, and the like.

Physical servers 1222 may host functionality directed to the operations of networking system 1220. Hereinafter servers 1222 may be referred to as server 1222, although server 1222 may include numerous servers hosting, for example, networking system 1220, as well as other content distribution servers, data stores, and databases. Data store 1224 may store content and data relating to, and enabling, operation of networking system 1220 as digital data objects. A data object, in particular embodiments, is an item of digital information typically stored or embodied in a data file, database, or record. Content objects may take many forms, including: text (e.g., American Standard Code for Information Interchange (ASCII), Standard Generalized Markup Language (SGML), HTML), images (e.g., jpeg, tif and gif), graphics (e.g., vector-based or bitmap), audio, video (e.g., mpeg), or other multimedia, and combinations thereof. Content object data may also include executable code objects (e.g., games executable within a browser window or frame), podcasts, and the like. Logically, data store 1224 corresponds to one or more of a variety of separate and integrated databases, such as relational databases and object-oriented databases, that maintain information as an integrated collection of logically related records or files stored on one or more physical systems. Structurally, data store 1224 may generally include one or more of a large class of data storage and management systems. In particular embodiments, data store 1224 may be implemented by any suitable physical system(s) including components, such as one or more database servers, mass storage media, media library systems, storage area networks, data storage clouds, and the like. In one example embodiment, data store 1224 includes one or more servers, databases (e.g., MySQL), and/or data warehouses. Data store 1224 may include data associated with different networking system 1220 users and/or client systems 1230.

Client system 1230 is generally a computer or computing device including functionality for communicating (e.g., remotely) over a computer network. Client system 1230 may be a desktop computer, laptop computer, personal digital assistant (PDA), in- or out-of-car navigation system, smart phone or other cellular or mobile phone, or mobile gaming device, among other suitable computing devices. Client system 1230 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 1230 to enter addresses of specific network resources to be retrieved, such as resources hosted by networking system 1220. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is HTML. Other common web browser-supported languages and technologies include XML, the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 1230 desires to view a particular webpage (hereinafter also referred to as a target structured document) hosted by networking system 1220, the user's web browser, or other document rendering engine or suitable client application, formulates and transmits a request to networking system 1220. The request generally includes a URL or other document identifier as well as metadata or other information. By way of example, the request may include information identifying the user, such as a user identifier (ID), as well as information identifying or characterizing the web browser or operating system running on the user's client system 1230. The request may also include location information identifying a geographic location of the user's client system or a logical network location of the user's client system. The request may also include a timestamp identifying when the request was transmitted.

Although the example network environment described above and illustrated in FIG. 8 is described with respect to social networking system 1220a and game networking system 1220b, this disclosure encompasses any suitable network environment using any suitable systems. As an example and not by way of limitation, the network environment may include online media systems, online reviewing systems, online search engines, online advertising systems, or any combination of two or more such systems.

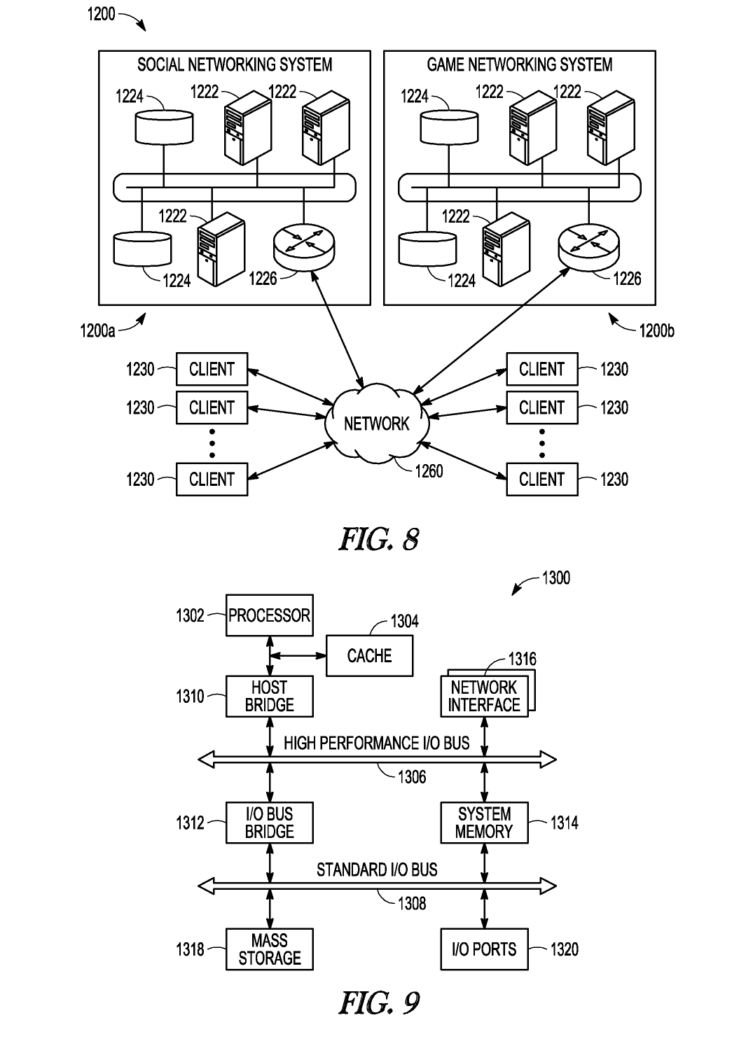

FIG. 9 illustrates an example computing system architecture, which may be used to implement a server 1222 or a client system 1230. In one embodiment, a hardware system 1300 comprises a processor 1302, a cache memory 1304, and one or more executable modules and drivers, stored on a tangible computer readable medium, directed to the functions described herein. Additionally, hardware system 1300 may include a high performance input/output (I/O) bus 1306 and a standard I/O bus 1308. A host bridge 1310 may couple processor 1302 to high performance I/O bus 1306, whereas I/O bus bridge 1312 couples the two buses 1306 and 1308 to each other. A system memory 1314 and one or more network/communication interfaces 1316 may couple to bus 1306. Hardware system 1300 may further include video memory (not shown) and a display device (not shown) coupled to the video memory. Mass storage 1318 and I/O ports 1320 may couple to bus 1308. Hardware system 1300 may optionally include a keyboard, a pointing device, and a display device (not shown) coupled to bus 1308. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 1300 are described in greater detail below. In particular, network interface 1316 provides communication between hardware system 1300 and any of a wide range of networks, such as an Ethernet (e.g., IEEE 802.3) network, a backplane, and so forth. Mass storage 1318 provides permanent storage for the data and programming instructions to perform the above-described functions implemented in servers 1222, whereas system memory 1314 (e.g., dynamic random-access memory (DRAM)) provides temporary storage for the data and programming instructions when executed by processor 1302. I/O ports 1320 are one or more serial and/or parallel communication ports that provide communication between additional peripheral devices, which may be coupled to hardware system 1300.

Hardware system 1300 may include a variety of system architectures, and various components of hardware system 1300 may be rearranged. For example, cache memory 1304 may be on-chip with processor 1302. Alternatively, cache memory 1304 and processor 1302 may be packed together as a “processor module,” with processor 1302 being referred to as the “processor core.” Furthermore, certain embodiments of the present disclosure may not require nor include all of the above components. For example, the peripheral devices shown coupled to standard I/O bus 1308 may couple to high performance I/O bus 1306. In addition, in some embodiments, only a single bus may exist, with the components of hardware system 1300 being coupled to the single bus. Furthermore, hardware system 1300 may include additional components, such as additional processors, storage devices, or memories.

An operating system manages and controls the operation of hardware system 1300, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a,” “an,” or “the” is intended to mean “one or more” unless specifically indicated to the contrary. In addition, it is to be understood that functional operations, such as “awarding,” “locating,” “permitting,” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features, and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized application programming interface (API) on a device, such as a mobile device (e.g., cellular phone, smart phone, personal Global Positioning System (GPS), PDA, personal gaming device, and the like), that makes API calls directly to a server. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

We claim:

1. A computer-implemented method, comprising:
processing data indicating that a player has selected an unavailable reward;
obtaining sponsored content based on the processed data;
presenting the sponsored content to the player;
processing data indicating that the player has completed an interaction with the sponsored content; and
providing the unavailable reward in response to processing the data that indicates that the player has completed the interaction with the sponsored content.

2. The computer-implemented method of claim 1, wherein the sponsored content comprises one or more of rich media content, video content, audio content, graphic content, interactive content, interactive advertisement, and textual content.

3. The computer-implemented method of claim 2, wherein the advertisement is selected based on characteristics of the player and a state of an online game.

4. The computer-implemented method of claim 1, wherein the obtaining of the sponsored content is performed in response to receiving data indicating that the player arrived at a friction point.

5. The computer-implemented method of claim 4, wherein the friction point corresponds to one or more of being low on a resource, a low level of available gaming time, being low on virtual currency, failing to complete a task associated with an online game, losing a competition associated with an online game, giving an online gift to a person, running low or out of time to complete a task or project within a game, and enlisting a friend to assist in performing an action.

6. The computer-implemented method of claim 1, wherein the interaction comprises one or more of playing a video, viewing content, viewing an advertisement, answering questions, performing an action associated with an online game, inviting a friend to view content, inviting a friend to participate in an online game, sharing an element via social media, purchasing an item, and sharing personal information.

7. The computer-implemented method of claim 1, wherein the reward comprises one or more of assisting a player in performing a task associated with an online game and awarding the player one or more of a resource, virtual currency, virtual items, virtual objects, and virtual energy.

8. A system comprising:
a content interaction module configured to process data indicating that a player has selected an unavailable reward, to process data indicating that the player has completed an interaction with sponsored content, and to provide the unavailable reward in response to processing the data that indicates that the player has completed the interaction with the sponsored content;
a content selection module configured to obtain the sponsored content based on the processed data indicating that the player has selected the unavailable reward; and
a content presentation module configured to present the sponsored content to the player.

9. The system of claim 8, wherein the sponsored content comprises one or more of rich media content, video content, audio content, graphic content, interactive content, interactive advertisement, and textual content.

10. The system of claim 9, wherein the advertisement is selected based on characteristics of the player and a state of an online game.

11. The system of claim 8, wherein the obtaining of the sponsored content is performed in response to receiving data indicating that the player arrived at a friction point.

12. The system of claim 11, wherein the friction point corresponds to one or more of being low on a resource, a low level of available gaming time, being low on virtual currency, failing to complete a task associated with an online game, losing a competition associated with an online game, giving an online gift to a person, running low or out of time to complete a task or project within a game, and enlisting a friend to assist in performing an action.

13. The system of claim 8, wherein the interaction comprises one or more of playing a video, viewing content, viewing an advertisement, answering questions, performing an action associated with an online game, inviting a friend to view content, inviting a friend to participate in an online game, sharing an element via social media, purchasing an item, and sharing personal information.

14. The system of claim 8, wherein the reward comprises one or more of assisting a player in performing a task associated with an online game and awarding the player one or more of a resource, virtual currency, virtual items, virtual objects, and virtual energy.

15. A non-transitory machine-readable medium storing instructions that, when executed by one or more processors of a machine, cause the machine to perform operations comprising:
processing data indicating that a player has selected an unavailable reward;
obtaining sponsored content based on the processed data indicating that the player has selected the unavailable reward;
presenting the sponsored content to the player;
processing data indicating that the player has completed an interaction with the sponsored content; and
providing the unavailable reward in response to processing the data that indicates that the player has completed the interaction with the sponsored content.

16. The non-transitory machine-readable medium of claim 15, wherein the sponsored content comprises one or more of rich media content, video content, audio content, graphic content, interactive content, interactive advertisement, and textual content.

17. The non-transitory machine-readable medium of claim 16, wherein the advertisement is selected based on characteristics of the player and a state of an online game.

18. The non-transitory machine-readable medium of claim 15, wherein the obtaining of the sponsored content is performed in response to receiving data indicating that the player arrived at a friction point.

19. The non-transitory machine-readable medium of claim 18, wherein the friction point corresponds to one or more of being low on a resource, a low level of available gaming time, being low on virtual currency, failing to complete a task associated with an online game, losing a competition associated with an online game, giving an online gift to a person, running low or out of time to complete a task or project within a game, and enlisting a friend to assist in performing an action.

20. The non-transitory machine-readable medium of claim 15, wherein the interaction comprises one or more of playing a video, viewing content, viewing an advertisement, answering questions, performing an action associated with an online game, inviting a friend to view content, inviting a friend to participate in an online game, sharing an element via social media, purchasing an item, and sharing personal information.
